(19) United States
(12) Patent Application Publication
(10) Pub. No.: US 2024/0272296 A1
(43) Pub. Date: Aug. 15, 2024

(54) RADAR SPEED MEASUREMENT METHOD, RADAR, RADAR SPEED MEASUREMENT DEVICE

(71) Applicant: AUTEL ROBOTICS CO., LTD., Shenzhen (CN)

(72) Inventors: Yanfeng DANG, Shenzhen (CN); Erxin ZHAO, Shenzhen (CN)

(21) Appl. No.: 18/648,851

(22) Filed: Apr. 29, 2024

Related U.S. Application Data
(63) Continuation of application No. PCT/CN2022/126199, filed on Oct. 19, 2022.

(30) Foreign Application Priority Data
Oct. 28, 2021 (CN) 202111266065.7

(51) Int. Cl. G01S 13/92; G01S 13/58; G01S 13/60

(52) U.S. Cl. CPC G01S 13/92; G01S 13/584; G01S 13/589; G01S 13/60

(57) ABSTRACT

Embodiments of the disclosure discloses a radar speed measuring method, a radar, a radar speed measuring device, a server and a storage medium. The method includes: acquiring a measurement parameter set between a radar and a target to be measured; determining position information of the target to be measured relative to the radar according to the measurement parameter set; measuring, by the radar, a relative moving speed of the target to be measured along a beam line-of-sight direction of the radar; and determining an absolute moving speed of the target to be measured along a moving direction thereof according to the relative moving speed and the position information.

### CROSS-REFERENCE TO RELATED APPLICATIONS

This application is a continuation of International Patent Application No. PCT/CN2022/126199, filed 19 Oct. 2022, which claims priority to and the benefit of Chinese Patent Application No. 2021112660657, filed 28 Oct. 2021, the entireties of which are hereby incorporated herein by reference.

### BACKGROUND

With the rapid development of the scale of cities around the world, the number of urban vehicles has increased, the transportation network has become more and more complex, and intercity trains, high-speed trains and other means of transportation have also developed at a high speed. While the urban transportation network brings convenience to people's life, the situation of numerous vehicles and roads also lays a hidden danger to the traffic safety and leaves more problems for traffic control and management.

In order to realize the judgment of traffic violations, radars are usually used for speed measurement to get the correct traveling speed of the vehicles. However, the traffic speed measuring radar only supports the working mode at a fixed altitude and a fixed pitch angle. Accordingly, the existing radar data recording models are basically established in a two-dimensional plane. In a three-dimensional space, the three-dimensional pitch angle will lead to the failure of the existing data recording models, and in a three-dimensional data collection plane, the existence of the pitch angle will make the data acquisition plane rotate, resulting in large errors in the existing speed determination results.

### SUMMARY

Embodiments of the disclosure relates to the technical field of radar speed measurement, and in particular to a radar speed measuring method, a radar, a radar speed measuring device, a server and a storage medium Embodiments of the disclosure provide a radar speed measuring method, a radar, a radar speed measuring device, a server and a storage medium to accurately a moving speed of a target at any altitude and pitch angle in a three-dimensional space.

In a first aspect, an embodiment of the disclosure provides a radar speed measuring method, including:
acquiring a measurement parameter set between a radar and a target to be measured;
determining position information of the target to be measured relative to the radar according to the measurement parameter set;
measuring, by the radar, a relative moving speed of the target to be measured along a beam line-of-sight direction of the radar; and
determining an absolute moving speed of the target to be measured along a moving direction thereof according to the relative moving speed and the position information.

In a second aspect, an embodiment of the disclosure further provides a radar, including:
one or more processors; and
a memory, configured to store one or more programs,
the one or more programs, when executed by the one or more processors, causing the one or more processors to implement the radar speed measuring method provided by any embodiment of the disclosure.

In a third aspect, an embodiment of the disclosure further provides a radar speed measuring device, including the plurality of the radars provided by any embodiment of the disclosure. The plurality of radars are configured to measure a speed of a same target to be measured to obtain an absolute moving speed of the target to be measured along a moving direction thereof.

Optionally, the measuring a speed of a same target to be measured to obtain an absolute moving speed of the target to be measured along a moving direction thereof includes:
measuring the speed of the same target to be measured by the plurality of radars to obtain absolute moving speed samples measured by the radars; and
performing vector averaging on the absolute moving speed samples to obtain the absolute moving speed.

Optionally, the performing vector averaging on the absolute moving speed samples to obtain the absolute moving speed includes: performing vector averaging on the absolute moving speed samples to obtain a vector average speed;
determining an error of each of the absolute moving speed samples relative to the vector average speed; and
taking, if each of the errors does not exceed a preset error, the vector average speed as the absolute moving speed.

Optionally, the performing vector averaging on the absolute moving speed samples to obtain the absolute moving speed includes:
performing vector averaging on the absolute moving speed samples to obtain a first vector average speed;
determining an error of each of the absolute moving speed samples relative to the first vector average speed;
screening out the absolute moving speed samples with the errors greater than a preset error, and performing vector averaging on the remaining absolute moving speed samples to obtain a second vector average speed; and
taking the second vector average speed as the absolute moving speed.

In a fourth aspect, an embodiment of the disclosure further provides a radar speed measuring device, including the plurality of the radars provided by any embodiment of the disclosure. The plurality of radars are configured to measure speeds of the plurality of targets to be measured to obtain absolute moving speeds of the plurality of targets to be measured along moving directions thereof.

Optionally, the moving directions of the plurality of targets to be measured are different from each other.

In a fifth aspect, an embodiment of the disclosure further provides a server, configured to:
receive an absolute moving speed of a target to be measured uploaded by the radar speed measuring device provided by any embodiment of the disclosure; or
receive absolute moving speeds of the plurality of targets to be measured uploaded by the radar speed measuring device provided by any embodiment of disclosure; and
display the absolute moving speed of the target to be measured or the absolute moving speeds of the plurality of targets to be measured on a display screen of the server such that a user determines whether the target to be measured or the plurality of targets to be measured is/are overspeed.

In a sixth aspect, an embodiment of the disclosure further provides an unmanned aerial vehicle, including the radar speed measuring device provided by any embodiment of the disclosure. The plurality of radars are installed on a nose of the unmanned aerial vehicle.

Optionally, the nose is provided with a gimbal, and the radars are mounted on the gimbal.

In a seventh aspect, an embodiment of the disclosure further provides an unmanned aerial vehicle, including the radar speed measuring device provided by any embodiment of the disclosure. The plurality of radars are respectively installed on a nose, a tail, a left side of a fuselage and a right side of the fuselage of the unmanned aerial vehicle.

In an eighth aspect, an embodiment of the disclosure further provides a computer-readable storage medium, storing a computer program. The program, when executed by a processor, implements the radar speed measuring method provided by any embodiment of the disclosure.

### BRIEF DESCRIPTION OF THE DRAWINGS

FIG. 1 is a flowchart of a radar speed measuring method provided by Embodiment I of the disclosure;

FIG. 2 is a schematic structural diagram of a radar three-dimensional data recording model provided by Embodiment I of the disclosure;

FIG. 3 is a schematic structural diagram of a radar speed measuring device provided by Embodiment II of the disclosure; and

FIG. 4 is a schematic structural diagram of a radar provided by Embodiment III of the disclosure.

### DETAILED DESCRIPTION

The disclosure will be further described in detail below with reference to the accompanying drawings and embodiments. It can be understood that the specific embodiments described herein are merely used to explain the disclosure but are not intended to limit the disclosure. In addition, it should also be noted that for the convenience of description, only parts related to the disclosure, but not all structures, are shown in the accompanying drawings.

It should be noted that before discussing the exemplary embodiments in more detail, some exemplary embodiments are described as processes or methods depicted as flowcharts. Although the flowchart describe the steps as sequential processes, many of the steps may be implemented in parallel, concurrently, or simultaneously. Besides, the sequence of the steps may be rearranged. The process may be terminated when its operation is completed, but there may be additional steps not included in the accompanying drawings. The processes may correspond to methods, functions, procedures, subroutines, subprograms and the like.

With the popularization and civilization of unmanned aerial vehicles, the cost of using the unmanned aerial vehicles is getting lower and lower, and they have been playing more and more important roles in the industries of police, urban management, agriculture, geology, electric power, disaster rescue and relief, and video shooting. The unmanned aerial vehicles can also meet the needs of many application scenarios in the transportation industry. As the “third eye flying in the air”, unmanned aerial vehicles provide great convenience for safety supervision and emergency support in the field of transportation. Due to the high volume of traffic and severe congestion, the unmanned aerial vehicle law enforcement agency can ensure that when a traffic officer fails to arrive on the scene in time, the unmanned aerial vehicle can be the first to arrive on the scene, and carry out aerial photography, recording, evidence collection and traffic dispersion to avoid more severe traffic congestion. Moreover, the unmanned aerial vehicles may also be used for intelligent tracking of illegal vehicles in highways or other open areas, and may also implement autonomous flight through the flight control system to realize intelligent monitoring. The embodiments of the disclosure are described in an example where radars are mounted on an unmanned aerial vehicle. Of course, the radars may also be mounted on other airborne devices, which is not limited in the embodiments of the disclosure.

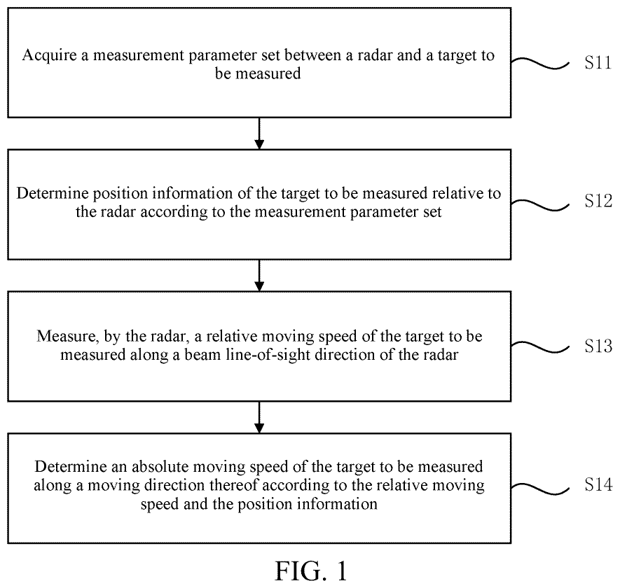

FIG. 1 is a flowchart of a radar speed measuring method provided by Embodiment I of the disclosure. This embodiment is applicable to the case of monitoring traveling speeds of various vehicles. The method may be executed by the radar provided by the embodiment of the disclosure. The radar may be implemented by hardware or hardware plus software and the plurality of radars constitute a radar speed measuring device. As shown in FIG. 1, the method specifically includes the following steps:

S11: Acquire a measurement parameter set between a radar and a target to be measured.

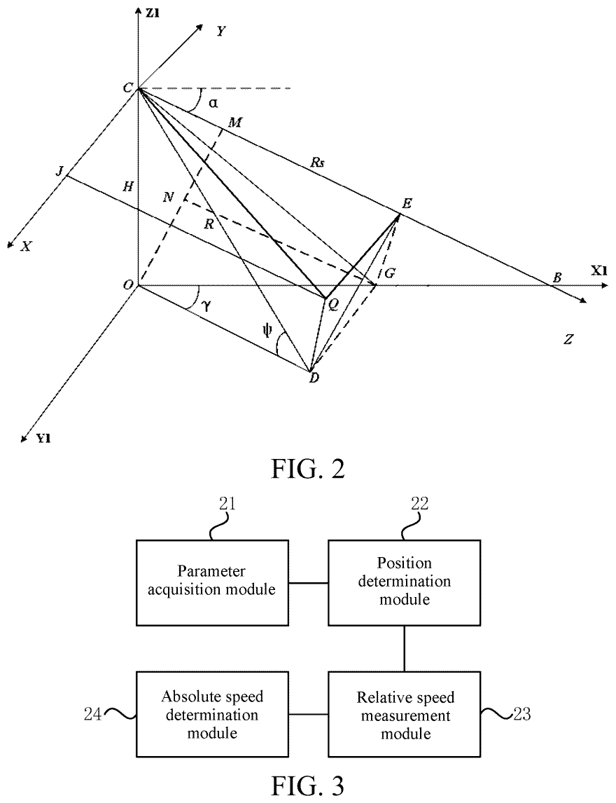

The target to be measured may be a vehicle such as a car and a ship. The radar used may be a millimeter-wave radar. The millimeter-wave radar has the characteristics of small size, light weight and high spatial resolution, has a strong capability to penetrate fog, smoke and dust, and can be used in all weathers and in all day. Moreover, the millimeter-wave radar has better anti-jamming and anti-stealth capabilities than others radars, and can distinguish and identify multiple small targets at the same time. The use of the millimeter-wave radar can improve the accuracy of the final speed measurement results. Optionally, the acquiring a measurement parameter set between a radar and a target to be measured at least includes: acquiring a target range, a target altitude difference and a target horizontal angle between the radar and the target to be measured. That is, the measurement parameter set may at least include the target range, the target altitude difference and the target horizontal angle, and may further include parameters such as the attitude of the airborne device mounted with the radar. For example, if the device to be mounted with the radar is an unmanned aerial vehicle, then the measurement parameter set may include parameters such as the attitude of the unmanned aerial vehicle. Specifically, as shown in FIG. 2, first, a radar coordinate system CXYZ may be established by taking the position C where the millimeter-wave radar is located as the origin, the plane perpendicular to the radar antenna as the X-axis and the direction of the radar center as the Z-axis and determining the Y-axis according to the right-hand rule. Then, a traveling coordinate system OX1Y1Z1 may be established by taking the projection O of the position of the millimeter-wave radar on the ground as the origin, the same direction as the X-axis as the Y1-axis, the upward direction perpendicular to the ground as the Z1-axis, and the direction perpendicular to the Y1-axis on the ground as the X1-axis. The X1-axis may be parallel with the moving direction of the target to be measured, which may be the road direction. The Z-axis and the X1-axis intersect at point B. It is assumed that there is a target to be measured at any point D in the scene, and the linear distance from the radar to point D is R. A straight line DG is made perpendicular to OB over point D, a straight line GE is made perpendicular to CB over point G, and DE⊥BC can be obtained based on the theorem of three perpendiculars. A DQI plane XCZ is made in the XCZ plane, a straight line QJ is made perpendicular to CX over point D, and OD, CD, CG, CQ and EQ are connected respectively. The target range between the millimeter-wave radar and the target to be measured is R, the target altitude difference is H, and the target horizontal angle is the included angle between the connecting line between the millimeter-wave radar and the target to be measured and the vertical plane of the ground where the radar's normal is located, i.e., ∠DCG. In addition, Rs is the slant range of the radar center, i.e., BC, ∠γ is the instantaneous azimuth of the target to be measured relative to the millimeter-wave radar, ∠ψ is the instantaneous pitch angle of the target to be measured relative to the millimeter-wave radar, and ∠α is the pitch angle of the radar center, i.e., the included angle between the direction of the radar's normal and the horizontal direction when the millimeter-wave radar works.

Optionally, the acquiring a target range between the radar and the target to be measured includes: transmitting, by the radar, frequency-modulated continuous wave signals, and receiving reflected echo signals of the target to be measured; performing digital down-conversion on the reflected echo signals, performing sorting to obtain a two-dimensional matrix, and obtaining a two-dimensional range Doppler matrix corresponding to the target to be measured by means of two-dimensional fast Fourier transform; and determining the target range according to the two-dimensional range Doppler matrix by means of a constant false alarm rate algorithm. Specifically, frequency-modulated continuous wave (FMCW) signals may be transmitted by the frequency-modulated continuous wave radar. The frequency of the frequency-modulated continuous wave signals may vary linearly in each frequency modulation period. When the reflected echo signals are received, digital down-conversion may be performed on the reflected echo signals first, and the sample values are sorted to obtain the two-dimensional matrix. Then, the time domain echo signals are transformed into the frequency domain by means of the two-dimensional (2-D) fast Fourier transform (FFT), thereby obtaining the two-dimensional Doppler matrix (RDM) corresponding to the target to be measured. Finally, the target range R of the target to be measured can be obtained by means of the constant false alarm rate (CFAR) algorithm.

Optionally, the acquiring a target horizontal angle between the radar and the target to be measured includes: determining a corresponding azimuth steering vector and a signal vector for direction-of-arrival estimation according to the target range and the target altitude difference; and estimating a direction-of-arrival according to the azimuth steering vector and the signal vector to obtain the target horizontal angle. The steering vector is the response of all array elements of the array antenna to a narrowband source having unit energy. Since the array response is different in different directions, the steering vector is correlated with the direction of the source, and the uniqueness of this correlation depends on the geometric structure of the array, so for the same array of array elements, each element of the steering vector has a unit amplitude. Specifically, for the target to be measured, in order to generate an N-dimensional vector, N antennas are required to form the radar array, and it is assumed that the array element interval of the array is d=λ/2, where λ is the wavelength. It is assumed that an angular position of a certain point target relative to the radar is (γ,ψ), where γ∈(−π/2,π/2) and ψ∈(0,π/2) respectively represent the instantaneous azimuth and the instantaneous pitch angle corresponding to any point target, then the signal vector s for estimating the direction-of-arrival (DOA) may be expressed as

$$s = A \cdot a ( γ , ψ )$$

where A represents the scattering coefficient of any point target, and a(γ, ψ) represents the signal steering vector and may be expressed as

$$a ( γ , ψ ) = {[ 1 , {e}^{- j 2 π dsin γ cos ψ / λ} , … {e}^{- j 2 π ( N - 1 ) dsin γ cos ψ / λ} ]}^{H}$$

for traditional one-dimensional DOA estimation, the steering vector considering only the azimuth may be expressed as

$$b = {[ 1 , {e}^{- j 2 π dsin γ / λ} , … {e}^{- j 2 π ( N - 1 ) dsin γ / λ} ]}^{H}$$

therefore, the azimuth may be estimated by the following method

$${\hat{γ}}_{traditional} = arg {max}_{γ} \vert {b}^{H} s \vert$$

In order to solve the problem of three-dimensional angle measurement, this embodiment considers the altitude difference H of any point target relative to the radar. Optionally, the radar is carried on an unmanned aerial vehicle, and the acquiring a target altitude difference between the radar and the target to be measured includes: measuring the target altitude difference by a flight control system of the unmanned aerial vehicle. That is, the altitude difference may be accurately measured by the flight control system of the unmanned aerial vehicle, and thereby used for two-dimensional DOA estimation of other point targets.

After the target range R and the target altitude difference H are determined, as shown in FIG. 2, the instantaneous pitch angle between the radar and the any point target may be expressed as

$$\hat{ψ} = a sin ( \frac{H}{R} )$$

therefore, considering the pitch angle caused by the altitude, the azimuth steering vector may be expressed as

$$a ( γ , \hat{ψ} ) = {[ 1 , {e}^{- j 2 π dsin γ cos \hat{ψ} / λ} , … {e}^{- j 2 π ( N - 1 ) dsin γ cos \hat{ψ} / λ} ]}^{H}$$

where d is the uniform array element interval, N is the number of receiving antennae, [ ]^{H} is the transpose conjugate of the matrix, and in this case, the target horizontal angle obtained by DOA estimation is

$${θ}_{radar} = arg {max}_{γ} \vert {a}^{H} ( γ , \hat{ψ} ) s \vert$$

based on the above steering vector expression, when angle measurement is performed by using a one-dimensional linear MIMO array, the angle between the radar and the target to be measured D is θ_{radar}, and with reference to the geometrical relationship in FIG. 2,

$$sin ∠ {θ}_{radar} = cos ∠ DCQ * sin ∠ QCE$$

according to the formula of the folding angle in solid geometry,

$$cos ∠ DCE = cos ∠ QCE * cos ∠ DCQ$$

thereby,

$$tan ∠ QCE = \frac{sin ∠ {θ}_{radar}}{cos ∠ DCE}$$

based on the geometrical relationship in FIG. 2, which may be further simplified as

$$QE = DG = R sin {θ}_{radar}$$

Since CG⊥DG,

$$∠ {θ}_{radar} = ∠ DCG$$

thereby, in a three-dimensional data recording model, in the presence of the altitude and pitch angle, the angle outputted by DOA estimation is ∠DCG. Further, the coordinates of any point in the scene in the coordinate system of the radar can be determined, thereby solving the problem of building a radar three-dimensional data recording model, and by building this model, the problem that the data recording plane changes as the altitude and the pitch angle change. The three-dimensional coordinates of any point D in the scene in the coordinate system of the radar are [DG, −GE, CE], and on this basis the following formula can be obtained

$$sin γ = \frac{DG}{\sqrt{{R}^{2} - {H}^{2}}}$$

Then, according to the geometrical relationship in FIG. 2,

$$CE = H sin α + OG cos α$$

based on similar triangles,

$$GE = \frac{BE * OC}{OB}$$

$$where$$

$$BE = Rs - CE$$

Thereby, the corresponding three-dimensional coordinates are

$$[ R sin {θ}_{radar} , - \frac{BE * OC}{OB} , H sin α + OG cos α ] .$$

In particular, the three-dimensional data recording model provided by this embodiment may be degraded to a traditional two-dimensional data recording model if the altitude and the pitch angle are set to zero at the same time. The method provided by this embodiment is applicable to both of them, i.e., the method provided by this embodiment has good extensibility.

S12: Determine position information of the target to be measured relative to the radar according to the measurement parameter set.

Specifically, since the radar can only measure the moving speed of the target to be measured relative to the radar, the relative position information of the target to be measured can be determined according to the obtained measurement parameter set, so that the moving speed of the target to be measured can be subsequently converted based on different directions according to the position information to obtain the actual moving speed of the target to be measured in the moving direction thereof.

S13: Measure, by the radar, a relative moving speed of the target to be measured along a beam line-of-sight direction of the radar.

The relative moving speed is a three-dimensional vector. Specifically, the moving speed measured by the radar at a certain altitude is the relative moving speed of the target to be measured along the beam line-of-sight direction, i.e., the projection of the actual moving speed on the radar beam.

S14: Determine an absolute moving speed of the target to be measured along a moving direction thereof according to the relative moving speed and the position information.

The absolute moving speed is also a three-dimensional vector. Optionally, the determining an absolute moving speed of the target to be measured along a moving direction thereof according to the relative moving speed and the position information at least includes: determining the absolute moving speed according to the relative moving speed, and an instantaneous azimuth and an instantaneous pitch angle of the target to be measured relative to the radar. That is, the position information may at least include the instantaneous azimuth and the instantaneous pitch angle. Specifically, when the target to be measured travels to point D in FIG. 2, the included angle (i.e., instantaneous azimuth) between the projection of the beam from the radar to the target to be measured on the ground and the projection of the radar's normal on the ground can be determined based on the target range, the target altitude difference, the target horizontal angle and the geometrical relationship in FIG. 2, and the included angle (i.e., instantaneous pitch angle) between the beam from the radar to the target to be measured and the horizontal direction may be determined based on the target range and the target altitude difference. Optionally, the target range, the target altitude difference, the target horizontal angle, the instantaneous azimuth and the instantaneous pitch angle satisfy the following relationships:

$$γ = a sin ( \frac{R sin {θ}_{radar}}{\sqrt{{R}^{2} - {H}^{2}}} )$$

$$ψ = a sin ( \frac{H}{R} )$$

where γ represents the instantaneous azimuth, ψ represents the instantaneous pitch angle, H represents the target altitude difference, R represents the target range, θ_{radar} represents the target horizontal angle, and a sin( ) represents an arcsin function.

Specifically, when the target to be measured moves closer to the radar, the actual measured speed gradually decreases due to the increase of the pitch angle, and when the target to be measured moves away from the radar, the actual measured speed gradually increases due to the decrease of the pitch angle. Therefore, in a case of measuring the speed of a vehicle, in order to obtain the accurate traveling speed of the vehicle for use as a basis for penalizing traffic violations, it is required to perform three-dimensional speed conversion to convert the speed measured in the coordinate system of the radar into a traveling coordinate system, so that the actual traveling speed of the vehicle can be obtained. As FIG. 2, assuming that the target to be measured travels at a speed v_{c} in a direction parallel with the road direction, the speed along the beam line-of-sight direction measured by the radar at any time is vᵣ, and vᵣ may be converted according to the instantaneous azimuth and the instantaneous pitch angle determined above to obtain v_{c}, thereby obtaining the absolute moving speed of the target to be measured along the moving direction thereof.

Optionally, according to the geometrical relationship in FIG. 2, the relative moving speed, the absolute moving speed, the instantaneous azimuth and the instantaneous pitch angle satisfy the following relationship:

$${v}_{c} = \frac{{v}_{r}}{cos γ cos ψ}$$

where v_{c} represents the absolute moving speed, vᵣ represents the relative moving speed, γ represents the instantaneous azimuth, and ψ represents the instantaneous pitch angle. Thereby, the speed along the beam line-of-sight direction can be projected back to the actual traveling direction, i.e., to the traveling coordinate system, to obtain the speed in the actual traveling direction, thereby providing an effective basis for the subsequent accurate punishment of violations.

On the basis of the above technical solution, optionally, the radar is carried on the unmanned aerial vehicle, and before the determining the absolute moving speed according to the relative moving speed, and an instantaneous azimuth and an instantaneous pitch angle of the target to be measured relative to the radar, the method further includes: acquiring an actual flight speed of the unmanned aerial vehicle and pitch angle information of a gimbal; and projecting the actual flight speed to the beam line-of-sight direction according to the pitch angle information to obtain a projected flight speed. Correspondingly, the determining the absolute moving speed according to the relative moving speed, and an instantaneous azimuth and an instantaneous pitch angle of the target to be measured relative to the radar includes: determining a target absolute speed of the target to be measured along the beam line-of-sight direction according to the relative moving speed and the projected flight speed; and determining the absolute moving speed according to the target absolute speed, the instantaneous azimuth and the instantaneous pitch angle. Specifically, the method provided by this embodiment is based on a working state at any altitude and pitch angle. The radar may be carried on an unmanned aerial vehicle, or may be carried on another radar-mounted airborne device which is carried on an unmanned aerial vehicle, so as to easily realize traffic supervision. When the radar is carried on an unmanned aerial vehicle, since the unmanned aerial vehicle can fly and move, the measurement during flight can be realized by considering the speed of the unmanned aerial vehicle, i.e., the radar speed measuring method provided by this embodiment is applicable to a dynamic model. Specifically, first, the actual flight speed of the unmanned aerial vehicle may be synthesized and projected to the beam line-of-sight direction by using the pitch angle information of the gimbal, and then, the target absolute speed of the target to be measured along the beam line-of-sight direction may be obtained by making a difference, so that the corresponding absolute moving speed can be determined according to the target absolute speed by using the above conversion method (for example, replacing vᵣ in the formula with the target absolute speed). In addition, when the unmanned aerial vehicle is in a hovering state, the radar speed measuring method provided by this embodiment may also be used to measure the speed of the target to be measured. In this case, the actual flight speed of the unmanned aerial vehicle is zero, the target absolute speed of the target to be measured along the beam line-of-sight direction can be directly converted to obtain the corresponding absolute moving speed according to the above conversion method (for example, replacing vᵣ in the formula with the target absolute speed) without projecting the speed of the unmanned aerial vehicle to the beam line-of-sight direction by using the pitch angle information of the gimbal. Therefore, the method is also applicable to a static model.

Optionally, the acquiring a measurement parameter set between a radar and a target to be measured at least includes: acquiring a target range, a target altitude difference and a target horizontal angle between the radar and the target to be measured; and
the determining an absolute moving speed of the target to be measured along a moving direction thereof according to the relative moving speed and the position information at least includes:
determining the absolute moving speed according to the relative moving speed, and an instantaneous azimuth and an instantaneous pitch angle of the target to be measured relative to the radar.

Optionally, the acquiring a target range between the radar and the target to be measured includes:
transmitting, by the radar, frequency-modulated continuous wave signals, and receiving reflected echo signals of the target to be measured;
performing digital down-conversion on the reflected echo signals, performing sorting to obtain a two-dimensional matrix, and obtaining a two-dimensional range Doppler matrix corresponding to the target to be measured by means of two-dimensional fast Fourier transform; and
determining the target range according to the two-dimensional range Doppler matrix by means of a constant false alarm rate algorithm.

Optionally, the acquiring a target horizontal angle between the radar and the target to be measured includes:
determining a corresponding azimuth steering vector and a signal vector for direction-of-arrival estimation according to the target range and the target altitude difference; and
estimating a direction-of-arrival according to the azimuth steering vector and the signal vector to obtain the target horizontal angle.

Optionally, the radar is carried on an unmanned aerial vehicle, and the acquiring a target altitude difference between the radar and the target to be measured includes:
measuring the target altitude difference by a flight control system of the unmanned aerial vehicle.

Optionally, the radar is carried on the unmanned aerial vehicle, and before the determining the absolute moving speed according to the relative moving speed, and an instantaneous azimuth and an instantaneous pitch angle of the target to be measured relative to the radar, the method further includes:
acquiring an actual flight speed of the unmanned aerial vehicle and pitch angle information of a gimbal; and
projecting the actual flight speed to the beam line-of-sight direction according to the pitch angle information to obtain a projected flight speed; and
correspondingly, the determining the absolute moving speed according to the relative moving speed, and an instantaneous azimuth and an instantaneous pitch angle of the target to be measured relative to the radar includes:
determining a target absolute speed of the target to be measured along the beam line-of-sight direction according to the relative moving speed and the projected flight speed; and
determining the absolute moving speed according to the target absolute speed, the instantaneous azimuth and the instantaneous pitch angle.

Optionally, the target range, the target altitude difference, the target horizontal angle, the instantaneous azimuth and the instantaneous pitch angle satisfy the following relationships:

$$γ = a sin ( \frac{R sin {θ}_{radar}}{\sqrt{{R}^{2} - {H}^{2}}} )$$

$$ψ = a sin ( \frac{H}{R} )$$

where γ represents the instantaneous azimuth, ψ represents the instantaneous pitch angle, H represents the target altitude difference, R represents the target range, θ_{radar} represents the target horizontal angle, and a sin( ) represents an arcsin function.

Optionally, the relative moving speed, the absolute moving speed, the instantaneous azimuth and the instantaneous pitch angle satisfy the following relationship:

$${v}_{c} = \frac{{v}_{r}}{cos γ cos ψ}$$

where v_{c} represents the absolute moving speed, vᵣ represents the relative moving speed, γ represents the instantaneous azimuth, and ψ represents the instantaneous pitch angle.

According to the technical solution provided by the embodiment of the disclosure, first, the measurement parameter set between the radar and the target to be measured is acquire acquired, then the position information of the target to be measured relative to the radar is determined according to the measurement parameter set, the relative moving speed of the target to be measured along the beam line-of-sight direction is measured by the radar, and thereby, the absolute moving speed of the target to be measured along the moving direction thereof is determined according to the relative moving speed and the position information. By calculating the relative position information of the target to be measured, the problem of speed conversion in a three-dimensional model is solved, and the speed of the target in the actual traveling direction is accurately measured at any altitude and any pitch angle in the three-dimensional space, which is more convenient for law enforcement agencies to determine and track violations.

FIG. 3 is a schematic structural diagram of a radar speed measuring device provided by Embodiment II of the disclosure. The radar speed measuring device may be implemented by hardware and/or software, and may be generally integrated in a radar and configured to execute the radar speed measuring method provided by any embodiment of the disclosure. As shown in FIG. 3, the radar speed measuring device includes:
a parameter acquisition module 21, configured to acquire a measurement parameter set between a radar and a target to be measured;
a position determination module 22, configured to determine position information of the target to be measured relative to the radar according to the measurement parameter set;
a relative speed measurement module 23, configured to measure, by the radar, a relative moving speed of the target to be measured along a beam line-of-sight direction of the radar; and
an absolute speed determination module 24, configured to determine an absolute moving speed of the target to be measured along a moving direction thereof according to the relative moving speed and the position information.

According to the technical solution provided by the embodiment of the disclosure, first, the measurement parameter set between the radar and the target to be measured is acquire acquired, then the position information of the target to be measured relative to the radar is determined according to the measurement parameter set, the relative moving speed of the target to be measured along the beam line-of-sight direction is measured by the radar, and thereby, the absolute moving speed of the target to be measured along the moving direction thereof is determined according to the relative moving speed and the position information. By calculating the relative position information of the target to be measured, the problem of speed conversion in a three-dimensional model is solved, and the speed of the target in the actual traveling direction is accurately measured at any altitude and any pitch angle in the three-dimensional space, which is more convenient for law enforcement agencies to determine and track violations.

On the basis of the above technical solution, optionally, the parameter acquisition module 21 is specifically configured to:
acquire a target range, a target altitude difference and a target horizontal angle between the radar and the target to be measured.

The absolute speed determination module 24 is specifically configured to:
determine the absolute moving speed according to the relative moving speed, and an instantaneous azimuth and an instantaneous pitch angle of the target to be measured relative to the radar.

On the basis of the above technical solution, optionally, the parameter acquisition module 21 includes:
a signal transceiving unit, configured to transmit, by the radar, frequency-modulated continuous wave signals, and receive reflected echo signals of the target to be measured;
a signal processing unit, configured to perform digital down-conversion on the reflected echo signals, perform sorting to obtain a two-dimensional matrix, and obtain a two-dimensional range Doppler matrix corresponding to the target to be measured by means of two-dimensional fast Fourier transform; and
a target range determination unit, configured to determine the target range according to the two-dimensional range Doppler matrix by means of a constant false alarm rate algorithm.

On the basis of the above technical solution, optionally, the parameter acquisition module 21 includes:
a steering vector determination unit, configured to determine a corresponding azimuth steering vector and a signal vector for direction-of-arrival estimation according to the target range and the target altitude difference; and
a target horizontal angle determination unit, configured to estimate a direction-of-arrival according to the azimuth steering vector and the signal vector to obtain the target horizontal angle.

On the basis of the above technical solution, optionally, the radar is carried on an unmanned aerial vehicle, and the parameter acquisition module 21 includes:
a target altitude difference measurement unit, configured to measure the target altitude difference by a flight control system of the unmanned aerial vehicle.

On the basis of the above technical solution, optionally, the radar is carried on an unmanned aerial vehicle, and the radar speed measuring apparatus further includes:
a flight parameter acquisition module, configured to, acquire an actual flight speed of the unmanned aerial vehicle and pitch angle information of a gimbal before the determining the absolute moving speed according to the relative moving speed, and an instantaneous azimuth and an instantaneous pitch angle of the target to be measured relative to the radar; and
a projected flight speed determination module, configured to project the actual flight speed to the beam line-of-sight direction according to the pitch angle information to obtain a projected flight speed.

Correspondingly, the absolute speed determination module 24 includes:
a target absolute speed determination unit, configured to determine a target absolute speed of the target to be measured along the beam line-of-sight direction according to the relative moving speed and the projected flight speed; and
an absolute speed determination unit, configured to determine the absolute moving speed according to the target absolute speed, the instantaneous azimuth and the instantaneous pitch angle.

The radar speed measuring apparatus provided by the embodiment of the disclosure may execute the radar speed measuring method provided by any embodiment of the disclosure, and has corresponding functional modules and beneficial effects of executing the method.

It is worth noting that in the embodiment of the radar speed measuring apparatus described above, the units and modules included are merely divided in accordance with the functional logic, but are not limited to the above division, as long as they can implement corresponding functions. In addition, the specific names of the functional units are merely for the convenience of distinguishing each other, and are not intended to limit the protection scope of the disclosure.

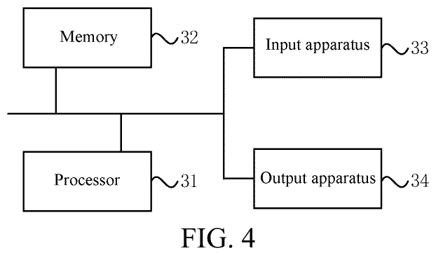

FIG. 4 is a schematic structural diagram of a radar provided by Embodiment of the disclosure, which shows a block diagram of an exemplary radar suitable for implementing the embodiment of the disclosure. The radar shown in FIG. 4 is merely an example, and should not impose any limitations to the functionality and applicability of the embodiment of the disclosure. As shown in FIG. 4, the radar includes a processor 31, a memory 32, an input apparatus 33 and an output apparatus 34. There may be one or more processors 31 in the radar.

FIG. 4 shows an example of one processor 31. The processor 31, the memory 32, the input apparatus 33 and the output apparatus 34 in the radar may be connected by buses or other means. FIG. 4 shows an example of connection by buses.

The memory 32, as a computer-readable storage medium, may be configured to store software programs, computer executable programs and modules, such as program instructions/modules (e.g., the parameter acquisition module 21, the position determination module 22, the relative speed measurement module 23 and the absolute speed determination module 24 in the radar speed measuring apparatus) corresponding to the radar speed measuring method in the embodiment of the disclosure. The processor 31 executes various functional applications and data processes of the radar by running the software programs, the instructions and the modules stored in the memory 32, thereby implementing the above radar speed measuring method.

The memory 32 may mainly include a program storage area and a data storage area. The program storage area may store an operating system and application programs required by at least one function. The data storage area may store data created according to the use of the radar, etc. In addition, the memory 32 may include a high-speed random access memory and a non-transitory memory, for example, at least one disc memory device, a flash memory device or other non-volatile solid-state memory devices. In some examples, the memory 32 may further include memories remotely disposed relative to the processor 31, and the remote memories may be connected to a radar through a network. Examples of the network include, but are not limited to, the Internet, an intranet, a local area network, a mobile communication network, and a combination thereof.

The input apparatus 33 may be configured to measure a relative moving speed of the target to be measured along a beam line-of-sight direction of the radar, and generate key signal inputs related to user settings and function control of the radar. The output apparatus 34 may be configured to feed back the measured speed data to the user.

Embodiment of the disclosure further provides a radar speed measuring device, including the plurality of the radars provided by any embodiment of the disclosure. The plurality of radars are configured to measure a speed of a same target to be measured to obtain an absolute moving speed of the target to be measured along a moving direction thereof. Specifically, the plurality of radars may be used to respectively measure the speed of the same target to be measured by using the radar speed measuring method provided by any embodiment of the disclosure, thereby further improving the accuracy of the measurement result. The plurality of radars each have an independent chip, and chip models of the radars may be identical.

Optionally, the measuring a speed of a same target to be measured to obtain an absolute moving speed of the target to be measured along a moving direction thereof includes: measuring the speed of the same target to be measured by the plurality of radars to obtain absolute moving speed samples measured by the radars; and performing vector averaging on the absolute moving speed samples to obtain the absolute moving speed. Further optionally, the performing vector averaging on the absolute moving speed samples to obtain the absolute moving speed includes: performing vector averaging on the absolute moving speed samples to obtain a vector average speed; determining an error of each of the absolute moving speed samples relative to the vector average speed; and taking, if each of the errors does not exceed a preset error, the vector average speed as the absolute moving speed. Alternatively, optionally, the performing vector averaging on the absolute moving speed samples to obtain the absolute moving speed includes: performing vector averaging on the absolute moving speed samples to obtain a first vector average speed; determining an error of each of the absolute moving speed samples relative to the first vector average speed; screening out the absolute moving speed samples with the errors greater than a preset error, and performing vector averaging on the remaining absolute moving speed samples to obtain a second vector average speed; and taking the second vector average speed as the absolute moving speed. Specifically, when the plurality of radars are used to measure the speed of the same target to be measured, an absolute moving speed sample of the target to be measured may be obtained by each of the radars respectively, and then the vector averaging may be performed on all the absolute moving speed samples to obtain a vector average speed as the final measurement result of the absolute moving speed. Of course, the absolute moving speed samples with large errors may also be screened out first, and then the vector averaging may be performed on the remaining absolute moving speed samples to obtain the vector average speed, thereby correcting the measurement result. After the vector average speed is determined, the error of each absolute moving speed sample relative to the vector average speed may be determined first, and only when each of the errors does not exceed the preset error, can the vector average speed be used as the final measurement result.

Embodiment of the disclosure further provides a radar speed measuring device, including the plurality of the radars provided by any embodiment of the disclosure. The plurality of radars are configured to measure speeds of the plurality of targets to be measured to obtain absolute moving speeds of the plurality of targets to be measured along moving directions thereof. Specifically, the plurality of radars may be used to respectively measure the speeds of the plurality of targets to be measured by using the radar speed measuring method provided by any embodiment of the disclosure, thereby further improving the speed measurement efficiency. The plurality of radars each have an independent chip, and chip models of the radars may be identical.

Optionally, the moving directions of the plurality of targets to be measured are different from each other, i.e., the plurality of radars may be used to measure the speeds of the plurality of targets to be measured with different moving directions at the same time, for example, measure speeds of passing vehicles at a road intersection.

Embodiment of the disclosure further provides a server. The server is configured to receive an absolute moving speed of a target to be measured uploaded by the radar speed measuring device provided by any embodiment of the disclosure; or receive absolute moving speeds of the plurality of targets to be measured uploaded by the radar speed measuring device provided by any embodiment of disclosure; and display the absolute moving speed of the target to be measured or the absolute moving speeds of the plurality of targets to be measured on a display screen of the server such that a user determines whether the target to be measured or the plurality of targets to be measured is/are overspeed.

Specifically, the server provided by this embodiment may receive the measurement results of the absolute moving speeds uploaded by the radar speed measuring device provided by any embodiment of the disclosure, i.e., may receive the measurement results of the radar speed measuring device for the same target to be measured or the measurement results of the radar speed measuring device for different targets to be measured. After the measurement results are received, the measurement results may be displayed by a display screen connected to the server, so that the traffic officer can check and statistically analyze the measurement results.

Embodiment of the disclosure further provides an unmanned aerial vehicle, including the radar speed measuring device provided by Embodiment of the disclosure. The plurality of radars are installed on a nose of the unmanned aerial vehicle. Specifically, when the radar speed measuring device measures the speed of the same target to be measured, it is only required to make measurements in one direction at one time. In this case, the radars may be installed on the nose of the unmanned aerial vehicle so as to measure the speed during the flight. It should be noted that when the radars are installed on the nose, the radars may be fixedly arranged on the nose. In this case, the unmanned aerial vehicle adjusts its flight attitude (e.g., flight altitude and flight speed) according to the motion state of the target to be measured so as to perform short-range tracking and speed measurement on the target to be measured, or the unmanned aerial vehicle may also directly measure the speed of the target to be measured at a distance. Preferably, the nose is provided with a gimbal, and the radars may be installed on the gimbal of the nose. In this case, the radars of the unmanned aerial vehicle may adjust their measuring ranges (i.e., measuring angles and measuring altitudes) with the rotation of the gimbal so as to perform short-range or long-range speed measurement on the target to be measured.

Embodiment of the disclosure further provides an unmanned aerial vehicle, including the radar speed measuring device provided by Embodiment of the disclosure. The plurality of radars are respectively installed on a nose, a tail, a left side of a fuselage and a right side of the fuselage of the unmanned aerial vehicle. Specifically, when the radar speed measuring device measures speeds of different targets to be measured, it may be required to make measurements in different directions at one time. In this case, the radars may be respectively installed on the nose, the tail, the left side of the fuselage and the right side of the fuselage of the unmanned aerial vehicle so as to facilitate the cooperative speed measurement on targets to be measured in multiple directions at the same time. The nose is the best position for arranging the radars. When the radars are installed on the tail, the left side of the fuselage and the right side of the fuselage, the implementations and principles are similar to those installed on the nose. The radars may be fixedly installed or rotate along with the gimbal or like products so as to measure the speeds of the targets to be measured. In order to avoid repetitions in contents, details will not be described here again.

Embodiment of the disclosure further provides a storage medium including computer executable instructions. The computer executable instructions, when executed by a computer processor, are configured to execute a radar speed measuring method. The method includes:
acquiring a measurement parameter set between a radar and a target to be measured;
determining position information of the target to be measured relative to the radar according to the measurement parameter set;
measuring, by the radar, a relative moving speed of the target to be measured along a beam line-of-sight direction of the radar; and
determining an absolute moving speed of the target to be measured along a moving direction thereof according to the relative moving speed and the position information.

The storage medium may be any of various types of memory devices or storage devices. The term “storage medium” is intended to include: an installation medium, such as a CD-ROM, a floppy disk or a magnetic tape apparatus; a computer system memory or random access memory, such as a DRAM, a DDR RAM, an SRAM, an EDO RAM, a Rambus RAM, etc.; a non-volatile memory, such as a flash memory, a magnetic medium (e.g., a hard disk or an optical storage); and a register or other similar types of memory elements, etc. The storage medium may also include other types of memories or combinations thereof. In addition, the storage medium may be located in a computer system in which programs are executed, or may be located in a different second computer system, which is connected to the computer system through a network (such as the Internet). The second computer system may provide program instructions to the computer for execution. The term “storage medium” may include two or more storage media that may reside in different positions (for example, in different computer systems connected through a network). The storage medium may store program instructions (e.g., specifically implemented as computer programs) executable by one or more processors.

Of course, according to the storage medium including computer executable instructions provided by the embodiment of the disclosure, the computer executable instructions are not limited to the above-mentioned method operations, and may also execute related operations in the radar speed measuring method provided by any embodiment of the disclosure.

The computer-readable signal medium may include a data signal being in a baseband or transmitted as a part of a carrier, which carries a computer-readable program code. A data signal propagated in such a way may assume the plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device.

The program code included in the computer-readable medium may be transmitted by using any suitable medium, including but not limited to, wireless transmission, a wire, an optical cable, radio frequency (RF) or the like, or any other suitable combination thereof.

The embodiment of the disclosure provides the radar speed measuring method. First, the measurement parameter set between the radar and the target to be measured is acquire acquired, then the position information of the target to be measured relative to the radar is determined according to the measurement parameter set, the relative moving speed of the target to be measured along the beam line-of-sight direction is measured by the radar, and thereby, the absolute moving speed of the target to be measured along the moving direction thereof is determined according to the relative moving speed and the position information. According to the radar speed measuring method provided by the embodiment of the disclosure, by calculating the relative position information of the target to be measured, the problem of speed conversion in a three-dimensional model is solved, and the speed of the target in the actual traveling direction is accurately measured at any altitude and any pitch angle in the three-dimensional space, which is more convenient for law enforcement agencies to determine and track violations.

According to the descriptions related to the implementations above, a person skilled in the art may clearly learn that the disclosure may be implemented by software and necessary general-purpose hardware, and definitely also by hardware, but in many cases, the former is a better implementation. Based on such an understanding, the technical solutions of the disclosure essentially, or the part contributing to the prior art may be implemented in the form of a software product. The computer software product may be stored in a computer-readable storage medium, such as a floppy disk, a read-only memory (ROM), a random access memory (RAM), a flash memory (FLASH), a hard disk or an optical disk of a computer, and includes several instructions for causing an electronic device (which may be a personal computer, a server, a network device, or the like) to execute the methods described in the embodiments of the disclosure.

It should be noted that the above is only the preferred embodiments of the disclosure and the technical principles applied. Those skilled in the art will understand that the disclosure is not limited to the specific embodiments described herein, and for those skilled in the art, various obvious changes, readjustments and substitutions may be made without departing from the protection scope of the disclosure. Therefore, although the disclosure has been described in detail through the above embodiments, the disclosure is not limited to the above embodiments, but may include more other equivalent embodiments without departing from the concept of the disclosure, and the scope of the disclosure depends on the scope of the appended claims.

What is claimed is:

1. A radar speed measuring method, comprising:
acquiring a measurement parameter set between a radar and a target to be measured;
determining a position information of the target to be measured relative to the radar according to the measurement parameter set;
measuring, by the radar, a relative moving speed of the target to be measured along a beam line-of-sight direction of the radar; and
determining an absolute moving speed of the target to be measured along a moving direction thereof according to the relative moving speed and the position information.

2. The radar speed measuring method according to claim 1, wherein the acquiring the measurement parameter set between the radar and the target to be measured at least comprises: acquiring a target range, a target altitude difference and a target horizontal angle between the radar and the target to be measured; and
the determining the absolute moving speed of the target to be measured along the moving direction thereof according to the relative moving speed and the position information at least comprises:
determining the absolute moving speed according to the relative moving speed, and an instantaneous azimuth and an instantaneous pitch angle of the target to be measured relative to the radar.

3. The radar speed measuring method according to claim 2, wherein the acquiring the target range between the radar and the target to be measured comprises:
transmitting, by the radar, frequency-modulated continuous wave signals, and receiving reflected echo signals of the target to be measured;
performing digital down-conversion on the reflected echo signals, performing sorting to obtain a two-dimensional matrix, and obtaining a two-dimensional range Doppler matrix corresponding to the target to be measured by means of two-dimensional fast Fourier transform; and
determining the target range according to the two-dimensional range Doppler matrix by means of a constant false alarm rate algorithm.

4. The radar speed measuring method according to claim 2, wherein the acquiring the target horizontal angle between the radar and the target to be measured comprises:
determining a corresponding azimuth steering vector and a signal vector for direction-of-arrival estimation according to the target range and the target altitude difference; and
estimating a direction-of-arrival according to the azimuth steering vector and the signal vector to obtain the target horizontal angle.

5. The radar speed measuring method according to claim 2, wherein the radar is mounted on an unmanned aerial vehicle, and the acquiring the target altitude difference between the radar and the target to be measured comprises:
measuring the target altitude difference by a flight control system of the unmanned aerial vehicle.

6. The radar speed measuring method according to claim 5, wherein the radar is mounted on the unmanned aerial vehicle, and before the determining the absolute moving speed according to the relative moving speed, and the instantaneous azimuth and the instantaneous pitch angle of the target to be measured relative to the radar, the method further comprises:
acquiring an actual flight speed of the unmanned aerial vehicle and pitch angle information of a gimbal; and
projecting the actual flight speed to the beam line-of-sight direction according to the pitch angle information to obtain a projected flight speed; and
correspondingly, the determining the absolute moving speed according to the relative moving speed, and the instantaneous azimuth and the instantaneous pitch angle of the target to be measured relative to the radar comprises:
determining a target absolute speed of the target to be measured along the beam line-of-sight direction according to the relative moving speed and the projected flight speed; and
determining the absolute moving speed according to the target absolute speed, the instantaneous azimuth and the instantaneous pitch angle.

7. The radar speed measuring method according to claim 6, wherein the target range, the target altitude difference, the target horizontal angle, the instantaneous azimuth and the instantaneous pitch angle satisfy the following relationships:
$$γ = a sin ( \frac{R sin {θ}_{radar}}{\sqrt{{R}^{2} - {H}^{2}}} )$$
$$ψ = a sin ( \frac{H}{R} )$$
wherein γ represents the instantaneous azimuth, ψ represents the instantaneous pitch angle, H represents the target altitude difference, R represents the target range, θ_{radar} represents the target horizontal angle, and a sin( ) represents an arcsin function.

8. The radar speed measuring method according to claim 6, wherein the relative moving speed, the absolute moving speed, the instantaneous azimuth and the instantaneous pitch angle satisfy the following relationship:
$${v}_{c} = \frac{{v}_{r}}{cos γ cos ψ}$$
wherein v_{c} represents the absolute moving speed, vᵣ represents the relative moving speed, γ represents the instantaneous azimuth, and ψ represents the instantaneous pitch angle.

9. A radar, comprising:
one or more processors; and
a memory, configured to store one or more programs,
the one or more programs, when executed by the one or more processors, causing the one or more processors to perform a radar speed measuring method, where the radar speed measuring method, comprising:
acquiring a measurement parameter set between a radar and a target to be measured;
determining a position information of the target to be measured relative to the radar according to the measurement parameter set;
measuring, by the radar, a relative moving speed of the target to be measured along a beam line-of-sight direction of the radar; and
determining an absolute moving speed of the target to be measured along a moving direction thereof according to the relative moving speed and the position information.

10. The radar according to claim 9, wherein the processor further comprises:
determining the absolute moving speed according to the relative moving speed, and an instantaneous azimuth and an instantaneous pitch angle of the target to be measured relative to the radar.

11. The radar according to claim 10, wherein the acquiring the target range between the radar and the target to be measured comprises:
transmitting, by the radar, frequency-modulated continuous wave signals, and receiving reflected echo signals of the target to be measured;
performing digital down-conversion on the reflected echo signals, performing sorting to obtain a two-dimensional matrix, and obtaining a two-dimensional range Doppler matrix corresponding to the target to be measured by means of two-dimensional fast Fourier transform; and
determining the target range according to the two-dimensional range Doppler matrix by means of a constant false alarm rate algorithm.

12. The radar according to claim 10, wherein the acquiring the target horizontal angle between the radar and the target to be measured comprises:
determining a corresponding azimuth steering vector and a signal vector for direction-of-arrival estimation according to the target range and the target altitude difference; and
estimating a direction-of-arrival according to the azimuth steering vector and the signal vector to obtain the target horizontal angle.

13. The radar according to claim 10, wherein the radar is mounted on an unmanned aerial vehicle, and the acquiring the target altitude difference between the radar and the target to be measured comprises:
measuring the target altitude difference by a flight control system of the unmanned aerial vehicle.

14. The radar speed measuring method according to claim 13, wherein the radar further comprises:
acquiring an actual flight speed of the unmanned aerial vehicle and pitch angle information of a gimbal; and
projecting the actual flight speed to the beam line-of-sight direction according to the pitch angle information to obtain a projected flight speed; and
correspondingly, the determining the absolute moving speed according to the relative moving speed, and the instantaneous azimuth and the instantaneous pitch angle of the target to be measured relative to the radar comprises:
determining a target absolute speed of the target to be measured along the beam line-of-sight direction according to the relative moving speed and the projected flight speed; and
determining the absolute moving speed according to the target absolute speed, the instantaneous azimuth and the instantaneous pitch angle.

15. The radar according to claim 14, wherein the target range, the target altitude difference, the target horizontal angle, the instantaneous azimuth and the instantaneous pitch angle satisfy the following relationships:
$$γ = a sin ( \frac{R sin {θ}_{radar}}{\sqrt{{R}^{2} - {H}^{2}}} )$$
$$ψ = a sin ( \frac{H}{R} )$$
wherein γ represents the instantaneous azimuth, ψ represents the instantaneous pitch angle, H represents the target altitude difference, R represents the target range, θ_{radar} represents the target horizontal angle, and a sin( ) represents an arcsin function.

16. The radar according to claim 15, wherein the relative moving speed, the absolute moving speed, the instantaneous azimuth and the instantaneous pitch angle satisfy the following relationship:
$${v}_{c} = \frac{{v}_{r}}{cos γ cos ψ}$$
wherein v_{c} represents the absolute moving speed, vᵣ represents the relative moving speed, γ represents the instantaneous azimuth, and ψ represents the instantaneous pitch angle.

17. A radar speed measuring device, comprising the plurality of the radars, the plurality of radars being configured to measure a speed of a same target to be measured to obtain an absolute moving speed of the target to be measured along a moving direction thereof, wherein a radar comprises, one or more processors; and
a memory, configured to store one or more programs,
the one or more programs, when executed by the one or more processors, causing the one or more processors to perform a radar speed measuring method, wherein the radar speed measuring method, comprising:
acquiring a measurement parameter set between a radar and a target to be measured;
determining a position information of the target to be measured relative to the radar according to the measurement parameter set;
measuring, by the radar, a relative moving speed of the target to be measured along a beam line-of-sight direction of the radar; and
determining an absolute moving speed of the target to be measured along a moving direction thereof according to the relative moving speed and the position information.

18. The radar speed measuring device according to claim 17, wherein the measuring a speed of a same target to be measured to obtain an absolute moving speed of the target to be measured along a moving direction thereof comprises:
measuring the speed of the same target to be measured by the plurality of radars to obtain absolute moving speed samples measured by the radars; and
performing vector averaging on the absolute moving speed samples to obtain the absolute moving speed.

19. The radar speed measuring device according to claim 11, wherein the performing vector averaging on the absolute moving speed samples to obtain the absolute moving speed comprises:
performing vector averaging on the absolute moving speed samples to obtain a vector average speed;
determining an error of each of the absolute moving speed samples relative to the vector average speed; and
taking, if each of the errors does not exceed a preset error, the vector average speed as the absolute moving speed.

20. The radar speed measuring device according to claim 11, wherein the performing vector averaging on the absolute moving speed samples to obtain the absolute moving speed comprises:
performing vector averaging on the absolute moving speed samples to obtain a first vector average speed;
determining an error of each of the absolute moving speed samples relative to the first vector average speed;
screening out the absolute moving speed samples with the errors greater than a preset error, and performing vector averaging on the remaining absolute moving speed samples to obtain a second vector average speed; and
taking the second vector average speed as the absolute moving speed.
